(19) United States
(12) Patent Application Publication
(10) Pub. No.: US 2022/0102730 A1
(43) Pub. Date: Mar. 31, 2022

(54) ELECTROLYTIC COPPER FOIL AND NEGATIVE CURRENT COLLECTOR OF LITHIUM SECONDARY BATTERY

(71) Applicant: Industrial Technology Research Institute, Hsinchu (TW)

(72) Inventor: Chiu-Yen Chiu, Hsinchu County (TW)

(73) Assignee: Industrial Technology Research Institute, Hsinchu (TW)

(21) Appl. No.: 17/407,127

(22) Filed: Aug. 19, 2021

Related U.S. Application Data
(60) Provisional application No. 63/084,551, filed on Sep. 28, 2020.

(30) Foreign Application Priority Data
Jan. 7, 2021 (TW) 110100571

(51) Int. Cl. H01M 4/66; C25D 3/38; C25D 1/04

(52) U.S. Cl. CPC H01M 4/661; H01M 2004/027; C25D 1/04; C25D 3/38

(57) ABSTRACT

An electrolytic copper foil is provided, in which the average grain size of the electrolytic copper foil in cross-section measured by electron back scattered diffraction (EBSD) is 1 μm or less in diameter. Moreover, in an X-ray diffraction (XRD) pattern of a first surface of the electrolytic copper foil measured by X-ray diffraction, a ratio of the diffraction peak intensity of (111) crystal plane to the sum of the diffraction peak intensities of (111) crystal plane, (200) crystal plane, (220) crystal plane, and (311) crystal plane is 0.5 or more.

### CROSS-REFERENCE TO RELATED APPLICATION

This application claims the priority benefits of U.S. provisional application Ser. No. 63/084,551, filed on Sep. 28, 2020 and Taiwan application serial no. 110100571, filed on Jan. 7, 2021. The entirety of each of the above-mentioned patent applications is hereby incorporated by reference herein and made a part of this specification.

### BACKGROUND

### Technical Field

The disclosure relates to an electrolytic copper foil and a negative current collector of lithium secondary batteries including the electrolytic copper foil.

### Description of Related Art

Lithium secondary batteries are currently an important source of electricity for the green energy in the automobile industry. In order to reduce the volume or weight of the EV (electric vehicles) lithium battery to increase the energy density of the battery, the current development is to make the copper foil for a negative current collector of lithium batteries thinner, and the thickness of the copper foil has been gradually reduced from 8 μm to 4 μm.

However, as the copper foil becomes thinner, the difficulty in handling the copper foil increases, and the mechanical properties of the copper foil required are also higher. Therefore, it is necessary to develop a copper foil with high strength to avoid wrinkles or breakages.

In addition, the current Si/C anode material has the issue of expansion due to charging and discharging, so its copper foil needs to have sufficient strength to withstand the volume changes caused by the reaction of the anode active material and lithium ions.

### SUMMARY

The present disclosure provides an electrolytic copper foil with high mechanical strength.

The present disclosure also provides a negative current collector of lithium secondary batteries, which is capable of increasing the energy density of batteries.

The average grain size of the electrolytic copper foil of the present disclosure in cross-section measured by electron back scattered diffraction (EBSD) is 1 μm or less in diameter.

Moreover, in an X-ray diffraction (XRD) pattern of a first surface of the electrolytic copper foil measured by X-ray diffraction, a ratio of the diffraction peak intensity of a (111) crystal plane to the sum of the diffraction peak intensities of the (111) crystal plane, the (200) crystal plane, the (220) crystal plane, and the (311) crystal plane is 0.5 or more.

The negative current collector of lithium secondary batteries of the present disclosure includes the electrolytic copper foil mentioned above.

Based on the above, the present disclosure provides a thin electrolytic copper foil with high strength, which may be applied to the negative current collector of a lithium secondary battery, thereby increasing the energy density of the battery.

In order to make the mentioned features of the present disclosure more comprehensible, the following embodiments are described in detail with accompanied drawings to as follows.

### BRIEF DESCRIPTION OF THE DRAWINGS

FIG. 1 is an electron back scattered diffraction (EBSD) image of Experiment 8.

FIG. 2 is an electron back scattered diffraction (EBSD) image of Experiment 2.

FIG. 3 is an X-ray diffraction (XRD) pattern of Experiment 1 to Experiment 4 and Experiment 6 to Experiment 8.

### DESCRIPTION OF THE EMBODIMENTS

An embodiment of the present disclosure provides an electrolytic copper foil, where the average grain size in cross-section measured by electron back scattered diffraction (EBSD) is 1 μm or less in diameter. In one embodiment, the average grain size of the electrolytic copper foil in cross-section measured by EBSD is 0.5 μm or less in diameter. The conductivity of the electrolytic copper foil may be, for example, greater than or equal to 80% IACS, and greater than or equal to 90% IACS. In an X-ray diffraction (XRD) pattern of a first surface of the electrolytic copper foil measured by X-ray diffraction, a ratio of the diffraction peak intensity of a (111) crystal plane to the sum of the diffraction peak intensities of the (111) crystal plane, a (200) crystal plane, a (220) crystal plane, and a (311) crystal plane is 0.5 or more, which represents that a preferred direction of the electrolytic copper foil of the present disclosure is (111). In one embodiment, a thickness of the electrolytic copper foil is between 3 μm and 35 μm. In another embodiment, a thickness of the electrolytic copper foil is between 3 μm and 6 μm.

In addition, based on the total number of the plurality of grains of the electrolytic copper foil being 100%, 70% or more than 70% of the plurality of grains have an average grain size of, for example, 0.3 μm or less in diameter. Therefore, the electrolytic copper foil of the present disclosure has a large number of fine grains and may improve the material strength significantly. In one embodiment, the tensile strength of the electrolytic copper foil at room temperature is ≥600 MPa, and the yield strength of the electrolytic copper foil at 0.5% elongation is ≥350 MPa. After a heat treatment at 350° C. for 1 hour, the tensile strength of the electrolytic copper foil is ≥500 MPa, and the yield strength of the electrolytic copper foil at 0.5% elongation is ≥300 MPa. However, the present disclosure is not limited thereto. The tensile strength at room temperature or low temperature and the yield strength at 0.5% elongation may be further improved.

In one embodiment, the ratio of an average length of a short diameter to the average length of a long diameter of the plurality of grains of the electrolytic copper foil in cross-section is >0.5, which represents that the shape of a single grain of the electrolytic copper foil of the present disclosure is oval or roughly round.

Another embodiment of the present disclosure provides a negative current collector of lithium secondary batteries, including the electrolytic copper foil mentioned above. Since the thickness of the electrolytic copper foil may range from 3 μm to 35 μm, or even 3 μm to 6 μm, when applied to the negative current collector of the lithium battery, the volume and/or the weight of the electric vehicles lithium battery may be reduced, thereby increasing the energy density of the battery.

Several experiments are provided below to verify the efficacy of the present disclosure, but the present disclosure is not limited to the following content.

<Experiment 1 to Experiment 8>

A titanium drum is adopted as cathode, and titanium coated iridium oxide (IrO₂/Ti) is adopted as anode. A copper sulfate electroplating solution (the copper ion concentration is 60 g/L, the sulfuric acid concentration is 90 g/L, and the chloride ion concentration is 30 ppm in the electroplating solution) is adopted. With the parameters of the plating temperature being 35° C., the titanium drum speed being 800 rpm, and the current density being 50 A/dm², the nitrogen-containing organic additive numbered DP 102-L of Chemleader Corporation is adopted, and the additive amount is changed to 8.6 ppm, 43 ppm, 86 ppm, 129 ppm, 172 ppm, 215 ppm, 301 ppm, and 387 ppm for electroplating, until an electrolytic copper foil with a thickness of about 5 μm is formed. The electrolytic copper foil is removed from the surface of the titanium drum, washed with water, soaked in chromic acid aqueous solution, washed again with deionized water, and then dried.

<Analysis>

1. Tensile strength, elongation, and yield strength: measured by a tensile-testing machine (Instron 4465).

2. Roughness: Rz measured base on JIS B0601-1994 (ten-point average roughness), using Kosaka surface roughness measuring instrument (Model Type: SE 1700).

3. Grain size: EBSD is adopted to measure the diameter of grains of the electrolytic copper foil in cross-section.

4. Preferred direction of the electrolytic copper foil: to match the detection method, after electroplating the foil to 5 μm according to the method of the Experiment, analyse it with X-ray diffraction (XRD).

5. Conductivity (% IACS): the sheet resistance is measured by a four-point probe, and substitute with the thickness of the electrolytic copper foil for calculation.

6. Hardness: measured based on the Vickers hardness tester using 10 grams load cell (Indentec 2H-A).

7. Non-contact roughness: Rz measured base on ISO 25178 using Keyence VHX-7000.

The electrolytic copper foils of Experiments 1 to 8 were subjected to the above analysis, and the results are shown in Table 1 below.

TABLE 1

| | | | | Yield | | | | |
|---|---|---|---|---|---|---|---|---|
| | | | | strength | | | | |
| | | Tensile | | at 0.5% | | | | |
| | Additive | strength | Elongation | elongation | Roughness (μm) | | | Conductivity |
| Experiment | (ppm) | (MPa) | (%) | (MPa) | Ra | Ry | Rz | (% IACS) |
| 1 | 8.6 | 458 | 2.5 | 305 | 0.39 | 2.89 | 2.09 | 92.33 |
| 2 | 43 | 515 | 2.3 | 329 | 0.34 | 2.85 | 2.14 | 87.79 |
| 3 | 86 | 603 | 2.5 | 366 | 0.37 | 2.69 | 2.04 | 89.07 |
| 4 | 129 | 643 | 2.4 | 370 | 0.32 | 1.9 | 1.9 | 87.52 |
| 5 | 172 | 723 | 2.6 | 380 | 0.33 | 1.87 | 1.8 | 85.32 |
| 6 | 215 | 749 | 2.5 | 376 | 0.38 | 1.73 | 1.73 | 80.90 |
| 7 | 301 | 762 | 2.4 | 379 | 0.34 | 1.87 | 1.75 | 80.52 |
| 8 | 387 | 759 | 2.5 | 385 | 0.36 | 1.86 | 1.86 | 80.11 |

It can be seen from Table 1 that Experiments 1 to 8 all have high conductivity and low roughness. Moreover, the tensile strengths of Experiment 3 to Experiment 8 at room temperature are all ≥600 MPa, and the yield strengths of the electrolytic copper foils of Experiments 3 to 8 at 0.5% elongation are ≥350 MPa.

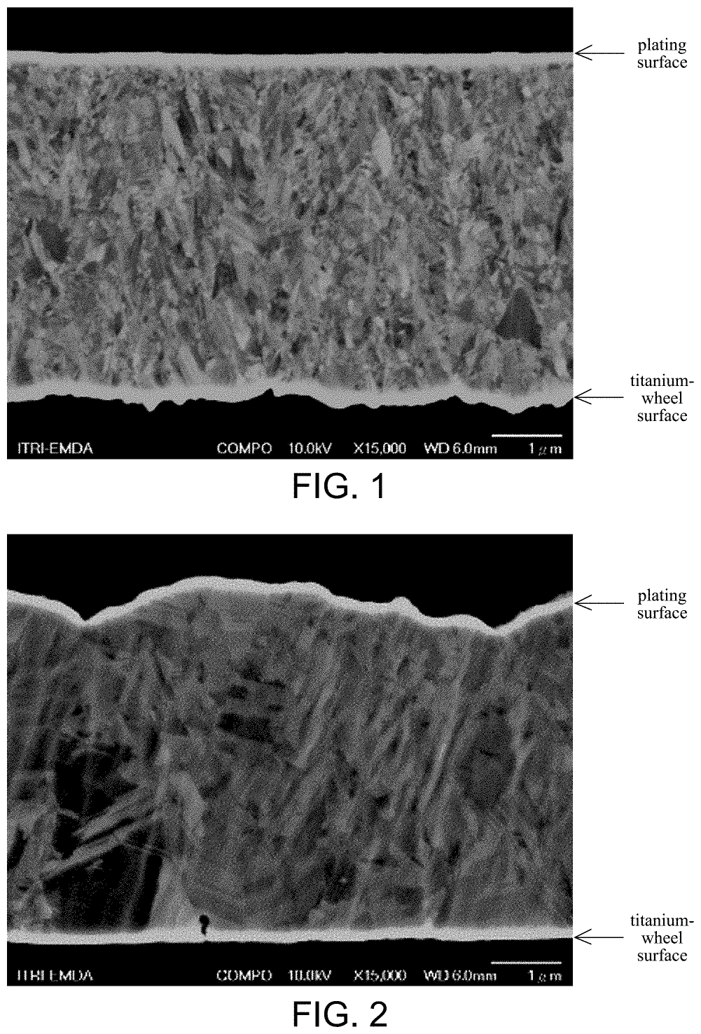

Then, the results of the grain size measured by EBSD are shown in FIG. 1, FIG. 2, and Table 2 below.

TABLE 2

| | Average | Drum side | Deposition | [Average short-diameter |
|---|---|---|---|---|
| | grain | grain | side | length/Average |
| | size | size | grain size | long-diameter length] |
| Experiment | (μm) | (μm) | (μm) | (μm) |
| 2 | 0.26 | 0.25 | 0.28 | >0.5 |
| 8 | 0.20 | 0.19 | 0.23 | >0.5 |

The “average grain size” in Table 2 refers to the average diameter of the plurality of grains in the entire electrolytic copper foil; the “Drum side grain size” refers to the average grain size observed with a drum side of 2.5 μm in diameter when the total thickness is 5 μm; the “Deposition side grain size” refers to the average grain size observed at 2.5 μm in diameter of the plating surface when the total thickness is 5 μm.

FIG. 1 and FIG. 2 are respectively the EBSD images of Experiment 8 and Experiment 2, and it can be seen from Table 2 that the average grain size of Experiment 2 and Experiment 8 are both less than 0.3 μm in diameter.

Table 3 is the result of the grain size of the electrolytic copper foil measured by EBSD, in which the electrolytic copper foil are prepared by the same method adopted as in Experiment 2 and Experiment 8.

TABLE 3

| | | | Grains size (μm) | |
|---|---|---|---|---|
| | Equivalent | | Drum | Deposition |
| Experiment | diameter (μm) | All | size | side |
| 2 | Average | 0.26 | 0.25 | 0.28 |
| | Maximum | 1.47 | 1.47 | 1.47 |
| | Number of grains | 384 | 267 | 143 |
| 8 | Average | 0.20 | 0.19 | 0.23 |
| | Maximum | 1.07 | 0.64 | 1.07 |
| | Number of grains | 586 | 397 | 208 |

Table 3 shows the same trend as Table 2; the average grain size of Experiment 2 and Experiment 8 are both less than 0.3 μm, and the grain size of Experiment 8 is smaller than that of Experiment 2.

Then, the electrolytic copper foils of Experiments 2, 4, 6, and 8 were analysed respectively at room temperature and after a heat treatment at 350° C. for an hour. The results are shown in Table 4 below.

TABLE 4

| | | | | | Yield | | | |
|---|---|---|---|---|---|---|---|---|
| | | | | | strength | | | |
| | | Tensile | | | at 0.5% | | Non-contact | |
| | | strength | | Elongation | elongation | Hardness | Rz | S Rz |
| State | Experiment | (MPa) | | (%) | (MPa) | (Hv) | (μm) | (μm) |
| Room | 2 | 515 | | 2.3 | 329 | 102 | 1.37 | 1.77 |
| Temperature | 4 | 643 | | 2.4 | 370 | 126 | 1.62 | 1.14 |
| | 6 | 749 | | 2.5 | 376 | 141 | 0.82 | 1.23 |
| | 8 | 759 | | 2.5 | 385 | 146 | 0.93 | 1.29 |
| 350° C. | 2 | 298 | 58% | 3.4 | 200 | 97 | 1.6 | 1.17 |
| for an hour | 4 | 440 | 68% | 2.71 | 304 | 115 | 0.93 | 1.34 |
| | 6 | 539 | 72% | 2.37 | 341 | 139 | 1.17 | 1.76 |
| | 8 | 586 | 77% | 2.29 | 351 | 142 | 1.24 | 1.65 |

In Table 4, in addition to showing the tensile strength values after the heat treatment at 350° C. for 1 hour, the following formula is further adopted to calculate the changes in tensile strength measured after the heat treatment at 350° C. for 1 hour, compared with the tensile strength of each example at room temperature: [Tensile strength after the heat treatment/Tensile strength at room temperature]×100%.

As shown in Table 4, the tensile strengths of the electrolytic copper foils of Experiments 4, 6, and 8 at room temperature are all greater than 600 MPa, and the yield strengths at 0.5% elongation are greater than 350 MPa. The tensile strengths of the electrolytic copper foils of Experiment 6 and Experiment 8 after the heat treatment at 350° C. for 1 hour are both greater than 500 MPa, and the yield strengths of the electrolytic copper foils of Experiments 4, 6, and 8 after the heat treatment at 350° C. for 1 hour at 0.5% elongation are all greater than 300 MPa.

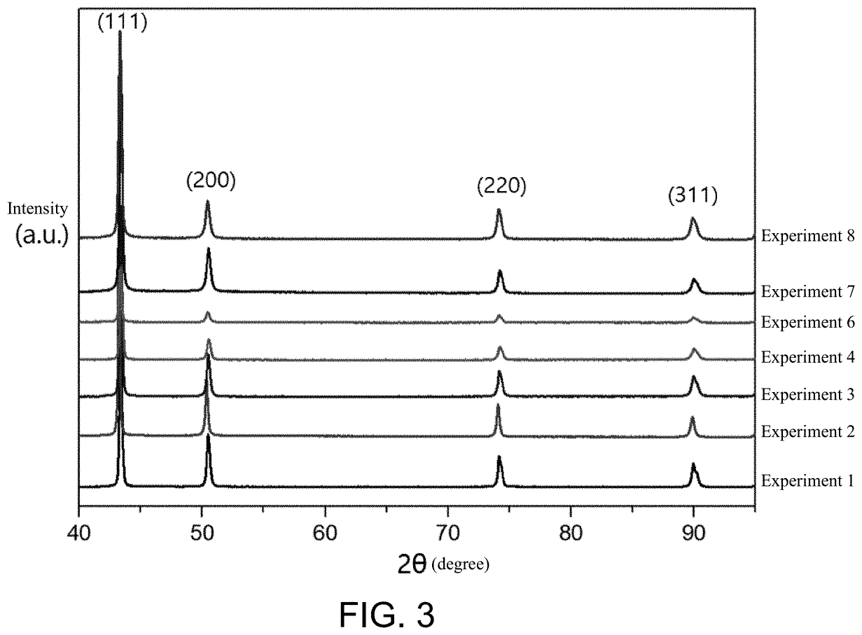

FIG. 3 is the XRD pattern of Experiments 1 to 4 and Experiments 6 to 8. The ratios of the diffraction peak intensity of different crystal plane to the sum of the diffraction peak intensities of all crystal planes in FIG. 3 is recorded in Table 5 below.

TABLE 5

| Experiment | I(111)/sum | I(200)/sum | I(220)/sum | I(311)/sum |
|---|---|---|---|---|
| 1 | 0.55 | 0.21 | 0.13 | 0.11 |
| 2 | 0.7 | 0.15 | 0.09 | 0.06 |
| 3 | 0.64 | 0.16 | 0.10 | 0.10 |
| 4 | 0.63 | 0.16 | 0.11 | 0.10 |
| 6 | 0.64 | 0.15 | 0.11 | 0.09 |
| 7 | 0.7 | 0.15 | 0.09 | 0.06 |
| 8 | 0.65 | 0.14 | 0.12 | 0.09 |

The “sum” in Table 5 represents the sum of the diffraction peak intensity I(111) of the (111) crystal plane, the diffraction peak intensity I(200) of the (200) crystal plane, the diffraction peak intensity I(220) of the (220) crystal plane, and the diffraction peak intensity I(311) of the (311) crystal plane.

It can be seen from Table 5 that in the XRD pattern measured by XRD on the surface of the electrolytic copper foils, the ratio of the diffraction peak intensity I(111) of (111) crystal plane to the sum of the diffraction peak intensities I(111), I(200), I(220), and I(311) of (111) crystal plane, (200) crystal plane, (220) crystal plane, and (311) crystal plane is 0.5 or more, preferably 0.6 or more. In addition, the diffraction peak intensity I(200) of the (200) crystal plane is larger than I(220), and the diffraction peak intensity I(200) of the (200) crystal plane is also larger than I(311). The diffraction peak intensity I(220) of the (220) crystal plane is between I(200) and I(311).

In sum, the electrolytic copper foil of the present disclosure may have a thin thickness and/or high strength, such that when applied to a negative current collector of a lithium secondary battery, the electrolytic copper foil of the present disclosure may be adapted to reduce the volume and/or weight of the electric vehicles lithium battery, thereby increasing the energy density of the battery.

Although the present disclosure has been disclosed in the above embodiments, they are not meant to limit the present disclosure. Anyone with common, general knowledge in the art can make changes and modifications without departing from the spirit and scope of the present disclosure. The scope of the present disclosure shall be determined by the scope of the claims.

What is claimed is:

1. An electrolytic copper foil, wherein:
an average grain size of the electrolytic copper foil in cross-section measured by electron back scattered diffraction is 1 μm or less in diameter; and
in an X-ray diffraction pattern of a first surface of the electrolytic copper foil measured by X-ray diffraction, a ratio of a diffraction peak intensity of a (111) crystal plane to a sum of diffraction peak intensities of a (111) crystal plane, a (200) crystal plane, a (220) crystal plane, and a (311) crystal plane is 0.5 or more.

2. The electrolytic copper foil according to claim 1, wherein the average grain size of the electrolytic copper foil in cross-section measured by electron back scattered diffraction is 0.5 μm or less in diameter.

3. The electrolytic copper foil according to claim 1, wherein based on a total number of a plurality of grains of the electrolytic copper foil being 100%, 70% or more than 70% of grains have the average grain size of 0.3 μm or less in diameter.

4. The electrolytic copper foil according to claim 1, wherein a tensile strength of the electrolytic copper foil at room temperature is ≥600 MPa, and a yield strength of the electrolytic copper foil at 0.5% elongation is ≥350 MPa.

5. The electrolytic copper foil according to claim 1, wherein after a heat treatment at 350° C. for 1 hour, a tensile strength of the electrolytic copper foil is ≥500 MPa, and a yield strength of the electrolytic copper foil at 0.5% elongation is ≥300 MPa.

6. The electrolytic copper foil according to claim 1, wherein a ratio of a short-diameter average length to a long-diameter average length of the plurality of grains of the electrolytic copper foil in cross-section is >0.5.

7. The electrolytic copper foil according to claim 1, wherein a thickness of the electrolytic copper foil ranges from 3 μm to 35 μm.

8. The electrolytic copper foil according to claim 1, wherein a thickness of the electrolytic copper foil ranges from 3 μm to 6 μm.

9. The electrolytic copper foil according to claim 1, wherein a conductivity of the electrolytic copper foil is ≥80% IACS.

10. A negative current collector of lithium secondary batteries, comprising the electrolytic copper foil according to claim 1.
